(19) United States
(12) Patent Application Publication
(10) Pub. No.: US 2026/0134727 A1
(43) Pub. Date: May 14, 2026

(54) SYSTEM AND METHOD FOR MITIGATING THE RISK OF OPERATING A VEHICLE USING A CONTEXTUALIZED RISK FACTOR

(71) Applicant: GM Global Technology Operations LLC, Detroit, MI (US)

(72) Inventors: Zulfiqar Haider Zaidi, Atlanta, GA (US); Armando Antonio Beltran Pacheco, Rochester Hills, MI (US); Azeem Sarwar, Rochester Hills, MI (US); Maureen Elizabeth August, Grosse Pointe Woods, MI (US)

(21) Appl. No.: 18/947,481

(22) Filed: Nov. 14, 2024

(51) Int. Cl. G07C 5/02; B60W 50/12; G06V 10/764; G06V 20/59; G06V 40/16; G06V 40/20; G06V 40/50; G10L 17/04; G10L 17/06

(52) U.S. Cl. CPC G07C 5/02; B60W 50/12; G06V 10/764; G06V 20/597; G10L 17/04; G10L 17/06; G06V 40/172; G06V 40/20; G06V 40/50

(57) ABSTRACT

A method for mitigating the risk of operating a vehicle using a contextualized risk factor includes receiving a first input from a plurality of first sensors within the vehicle and a second input from a plurality of second sensors outside the vehicle, determining a set of internal vehicle condition factors based on the first input, and weighing the internal vehicle condition factors, the second input, and the identity of a user within the vehicle to generate the contextualized risk factor. The identity and behavior of the user is recorded in a user profile which is added to a user profile database. When the contextualized risk factor is greater than a calibrated safety threshold, the vehicle may take at least one of an indirect measure or a direct measure. The vehicle may also send an alert to a third-party as to the presence of an unsafe driving environment.

### INTRODUCTION

The present disclosure generally relates to mitigating the risk of operating a vehicle, particularly by weighing a plurality of factors from both inside and outside the vehicle and generating a contextualized risk factor with respect to a driving environment, and allowing the vehicle to take at least one of an indirect or direct measure based on the contextualized risk factor.

Vehicles employ a variety of systems and techniques to mitigate the risk of operating a vehicle, including utilizing sensors that can analyze the surrounding environment of the vehicle and automatic emergency braking that can mitigate or even prevent a possible accident. However, with the advent of sophisticated emotional and mental analysis, as well as behavioral analysis, it is possible to not only consider the environment that surrounds the vehicle while employing risk mitigation techniques, but also consider the behavioral patterns of the driver and the passengers within the vehicle.

Thus, while current risk mitigation systems within vehicles achieve their intended purpose, there is a need for a new and improved system and method for mitigating the risk of operating a vehicle using a contextualized risk factor to accurately and effectively weigh a plurality of factors that may confront the driver of a vehicle from inside and outside the vehicle during the course of operating the vehicle so that proper mitigation action may be taken.

### SUMMARY

According to several aspects, A method for mitigating the risk of operating a vehicle using contextual information related to a user of the vehicle and an operating condition of the vehicle is provided. The method may include receiving a first input from a plurality of first sensors located within the vehicle, wherein the first input is indicative of an internal condition within the vehicle. The method may further include determining an identity of a user based on the first input and a user profile in a user profile database. The method may further include determining a set of internal vehicle condition factors of the internal condition within the vehicle based on the first input and the identity of the user. The method may further include receiving a second input from a plurality of second sensors mounted to the vehicle, wherein the second input is indicative of the operating condition of the vehicle. The method may further include determining a contextualized risk factor based on the internal vehicle condition factors and the second input. The method may further include comparing the contextualized risk factor to a calibrated safety threshold. The method may further include performing at least one action when the contextualized risk factor is above the calibrated safety threshold to mitigate the risk of operating the vehicle.

In an additional aspect of the present disclosure, receiving the first input may further include receiving the first input using at least one microphone, determining that the first input is human speech, generating a transcript of the first input, analyzing the first input using a sentiment analysis program, and analyzing the first input using a voice recognition program.

In another aspect of the present disclosure, determining the identity of the user may further include creating the user profile of the user based on the analysis of the first input by the voice recognition program when comparing the first input to each entry in the user profile database does not result in a match. Determining the identity of the user may further include adding the user profile to the user profile database. Determining the identity of the user may further include associating the set of internal vehicle condition factors with the user in the user profile database.

In an additional aspect of the present disclosure, determining the set of internal vehicle condition factors may further include generating a user mental and emotional state assessment based on the transcript of the first input and the analysis of the first input by the sentiment analysis program. Determining the set of internal vehicle condition factors may further include determining when an excessive third-party disturbance occurs based on the transcript of the first input. Determining the set of internal vehicle condition factors may further include determining the number of users in the vehicle based on a number of users identified by the voice recognition program. Determining the set of internal vehicle condition factors may further include determining when the speech of the user is affected based on the analysis of the first input by the sentiment analysis program and the analysis of the first input by the voice recognition program.

In another aspect of the present disclosure, receiving the first input may further include receiving the first input using at least one camera and classifying the user as one of either a driver or a passenger based on the position of the user within the vehicle.

In an additional aspect of the present disclosure, determining the identity of the user may further include analyzing the first input using a face recognition program. Determining the identity of the user may further include creating the user profile of the user based on the analysis of the first input by the face recognition program when comparing the first input to each entry in the user profile database does not result in a match. Determining the identity of the user may further include adding the user profile to the user profile database. Determining the identity of the user may further include associating the internal vehicle condition factors and the second input with the user in the user profile database.

In another aspect of the present disclosure, determining the set of internal vehicle condition factors may further include generating a user mental and emotional state assessment based on the activity tracked of the driver. Determining the set of internal vehicle condition factors may further include generating a user mental and emotional state assessment based on the activity tracked of the passenger. Determining the set of internal vehicle condition factors may further include determining the number of passengers in the vehicle based on the activity tracked of at least one passenger. Determining the set of internal vehicle condition factors may further include determining when an excessive disturbance occurs based on the activity tracked of the driver. Determining the set of internal vehicle condition factors may further include determining when an excessive third-party disturbance occurs based on the activity tracked of at least one passenger.

In an additional aspect of the present disclosure, receiving the first input may further include using at least one eye tracker to receive the first input, determining when the pupils of the user's eyes are in a dilated state or a non-dilated state, and determining the direction of the user's gaze.

In another aspect of the present disclosure, determining the set of internal vehicle condition factors may further include generating a user mental and emotional state assessment based on when the user's eyes are in the dilated state and determining when an excessive disturbance occurs based on the direction of the user's gaze.

In an additional aspect of the present disclosure, the second input may further include a current speed of the vehicle, a current acceleration of the vehicle, a detected speed limit of a roadway the vehicle is operating on, an ambient temperature of the environment in which the vehicle is operating, a precipitation intensity of the environment in which the vehicle is operating, a time of day of the environment in which the vehicle is operating, and a location of the vehicle.

In another aspect of the present disclosure, the method may further include receiving a third input from a server, wherein the third input is indicative of the environment surrounding the vehicle, including weather information of the environment in which the vehicle is operating and traffic information of the environment in which the vehicle is operating.

In an additional aspect of the present disclosure, determining the contextualized risk factor may further include weighing the set of internal vehicle condition factors, second input, and third input based on the identity of the user and generating the contextualized risk factor.

In another aspect of the present disclosure, performing at least one action when the contextualized risk factor is above the calibrated safety threshold may further include performing an indirect measure when the contextualized risk factor is greater than an arbitrary first margin above the calibrated safety threshold. Performing at least one action when the contextualized risk factor is above the calibrated safety threshold may further include performing the indirect measure when the contextualized risk factor persists in being relatively greater than the calibrated safety threshold over a period of time. Performing at least one action when the contextualized risk factor is above the calibrated safety threshold may further include performing a direct measure when the contextualized risk factor persists in being greater than the arbitrary first margin above the calibrated safety threshold over a period of time. Performing at least one action when the contextualized risk factor is above the calibrated safety threshold may further include performing the direct measure when the contextualized risk factor is greater than an arbitrary second margin above the calibrated safety threshold, wherein the arbitrary second margin is greater than the arbitrary first margin.

In an additional aspect of the present disclosure, the indirect measure may include playing a relaxing music track over a sound system within the vehicle and alerting the user to the risky operating conditions of the vehicle.

In another aspect of the present disclosure, the direct measure may further include temporarily limiting the speed of the vehicle and temporarily limiting the acceleration of the vehicle.

In an additional aspect of the present disclosure, performing the direct measure may further include analyzing the second input and determining based on the second input that an environment in which the vehicle is operating is safe to limit the agility of the vehicle.

In another aspect of the present disclosure, performing at least one action when the contextualized risk factor is above the calibrated safety threshold may further include alerting a third-party to the risky operating conditions of the vehicle.

In an additional aspect of the present disclosure, the calibrated safety threshold may be adjusted based on the internal vehicle condition factors, the second input, the third input, and the identity of the user.

In another aspect of the present disclosure, a method for mitigating the risk of operating a vehicle using contextual information related to a user of the vehicle and an operating condition of the vehicle is provided. The method may include receiving a first input from a plurality of first sensors located within the vehicle, wherein the first input is indicative of an internal condition within the vehicle. The method may further include determining an identity of a user based on the first input and a user profile in a user profile database. The method may further include determining a set of internal vehicle condition factors of the internal condition within the vehicle based on the first input and the identity of the user. The method may further include receiving a second input from a plurality of second sensors mounted to the vehicle, wherein the second input is indicative of the operating condition of the vehicle. The method may further include determining a contextualized risk factor based on the internal vehicle condition factors and the second input. The method may further include recording behavior of the user based on the internal vehicle condition factors and the second input into a plurality of historical/heuristic data points associated with the user profile. The method may further include comparing the contextualized risk factor to a calibrated safety threshold. The method may further include performing at least one action when the contextualized risk factor is above the calibrated safety threshold to mitigate the risk of operating the vehicle. The method may further include determining the at least one action is an indirect measure when the contextualized risk factor is greater than an arbitrary first margin above the calibrated safety threshold or when the contextualized risk factor persists in being relatively greater than the calibrated safety threshold over a period of time, wherein the indirect measure comprises playing a relaxing music track over a sound system within the vehicle and alerting the user to the risky operating conditions of the vehicle. The method may further include determining the at least one action is a direct measure when an environment in which the vehicle is operating in is safe to limit the agility of the vehicle and either the contextualized risk factor persists in being greater than the arbitrary first margin above the calibrated safety threshold over a period of time or the contextualized risk factor is greater than an arbitrary second margin above the calibrated safety threshold, wherein the arbitrary second margin is greater than the arbitrary first margin, wherein the direct measure comprises temporarily limiting the speed of the vehicle and temporarily limiting the acceleration of the vehicle.

In an additional aspect of the present disclosure, a method for mitigating the risk of operating a vehicle using contextual information related to a user of the vehicle and an operating condition of the vehicle is provided. The method may include receiving a first input from a plurality of first sensors located within the vehicle, wherein the first input is indicative of an internal condition within the vehicle. The method may further include determining an identity of a user based on the first input and a user profile in a user profile database. The method may further include determining a set of internal vehicle condition factors of the internal condition within the vehicle based on the first input and the identity of the user. The method may further include receiving a second input from a plurality of second sensors mounted to the vehicle, wherein the second input is indicative of the operating condition of the vehicle. The method may further include determining a contextualized risk factor based on the internal vehicle condition factors and the second input. The method may further include recording behavior of the user based on the internal vehicle condition factors and the second input into a plurality of historical/heuristic data points associated with the user profile. The method may further include comparing the contextualized risk factor to a calibrated safety threshold. The method may further include performing at least one action when the contextualized risk factor is above the calibrated safety threshold to mitigate the risk of operating the vehicle. The method may further include alerting a third-party to the presence of an unsafe driving environment for the vehicle when the contextualized risk factor is greater than an arbitrary margin above the calibrated safety threshold.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for mitigating a risk of operating a vehicle using contextual information related to a user of the vehicle and an operating condition of the vehicle according to an exemplary embodiment;

FIG. 2 is a diagram of the weighing of a set of internal vehicle condition factors, a second input, and a third input to determine a contextualized risk factor according to an exemplary embodiment;

FIG. 3A is a diagram for determining the set of internal vehicle condition factors based on data received from a plurality of microphones according to an exemplary embodiment;

FIG. 3B is a diagram for determining the set of internal vehicle condition factors based on data received from a plurality of cameras according to an exemplary embodiment;

FIG. 3C is a diagram for determining the set of internal vehicle condition factors based on data received from an eye tracker according to an exemplary embodiment;

FIG. 4 is a diagram of a method for determining which of either a direct measure or an indirect measure the vehicle will take based on the contextualized risk factor according to an exemplary embodiment;

FIG. 5 is a flowchart of a method for determining when to provide a warning alert to a third-party based on the contextualized risk factor according to an exemplary embodiment; and

FIG. 6 is a flowchart of a method for adding a user profile to a user profile database according to an exemplary embodiment.

### DETAILED DESCRIPTION

The following description is merely exemplary in nature and is not intended to limit the present disclosure, application, or uses.

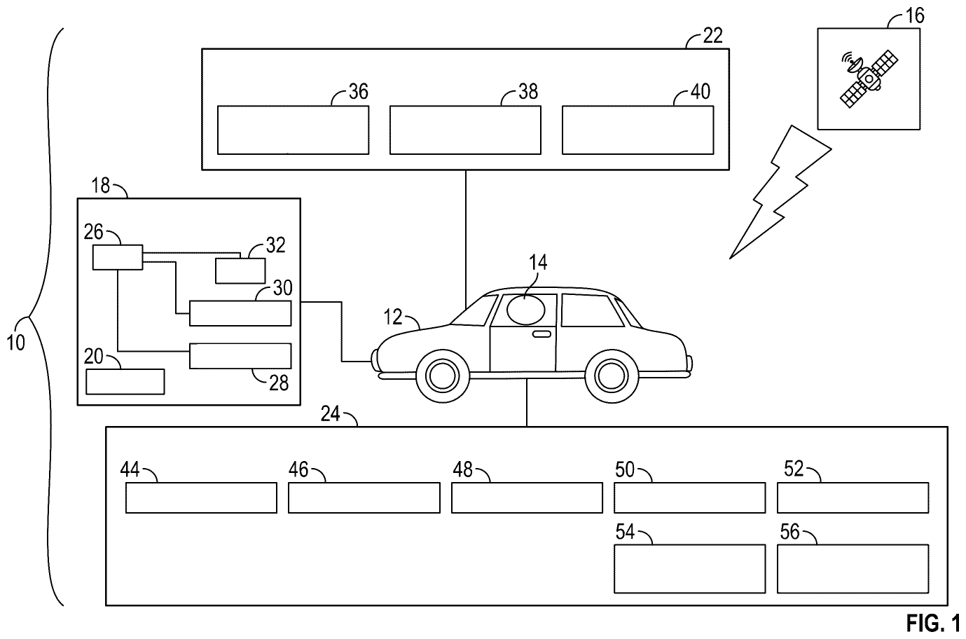

Referring to FIG. 1, a schematic diagram of a system for mitigating the risk of operating a vehicle using contextual information related to a user of the vehicle and an operating condition of the vehicle is generally indicated by reference number 10. The system 10 generally includes a vehicle 12, a user 14, and a server 16.

The vehicle 12 is a land vehicle such as a car, truck, etc. that can be operated by the user 14 or by an autonomous driving module. The vehicle 12 may have various levels of driving automation, including Level Five, Level Four, Level Three, and Level Two automation. For example, a Level Five system indicates “full automation,” referring to the full-time performance by an automated driving system of aspects of the dynamic driving task under a number of roadway and environmental conditions that can be managed by a human driver. A Level Four system indicates “high automation,” referring to the driving mode-specific performance by an automated driving system of aspects of the dynamic driving task, even if a human driver does not respond appropriately to a request to intervene. In Level Three vehicles, the vehicle systems perform the entire dynamic driving task (DDT) within the area that it is designed to do so. The vehicle operator is only expected to be responsible for the DDT-fallback when the vehicle 10 essentially “asks” the driver to take over if something goes wrong or the vehicle is about to leave the zone where it is able to operate. In Level Two vehicles, systems provide steering, brake/acceleration support, lane centering, and adaptive cruise control. However, even if these systems are activated, the vehicle operator at the wheel must be driving and constantly supervising the automated features. The vehicle 12 may include various actuator devices (not shown) used to achieve the above-described levels of automation. The actuator devices control one or more vehicle features including, but not limited to, a propulsion system, a transmission system, a steering system, and a brake system (not shown). In various embodiments, the vehicle features may further include interior and/or exterior vehicle features such as, but are not limited to, doors, a trunk, and cabin features such as air, music, lighting, etc. In the particular example provided in FIG. 1, the vehicle 12 includes a controller 18, a display 20, a plurality of first sensors 22, and a plurality of second sensors 24.

The controller 18 is a non-generalized, electronic control device having a preprogrammed digital computer or processor 26, a memory 28, a transceiver 30, and a plurality of input and output ports 32. The processor 26 may be a custom made or commercially available processor, a central processing unit (CPU), a graphics processing unit (GPU), an auxiliary processor among several processors associated with the controller 18, a semiconductor-based microprocessor (in the form of a microchip or chip set), a microprocessor, a combination thereof, or generally a device for executing instructions. The memory 28 is used to store data such as control logic, software applications, instructions, computer code, data, lookup tables, etc. The memory 28 includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code. The processor 26 is configured to execute the code or instructions.

The transceiver 30 is configured to wirelessly communicate with a hotspot using Wi-Fi protocols under IEEE 802.11x standards. The transceiver 30 is also configured to wirelessly communicate using cellular data communication under GSMA standards, such as SGP.02, SGP.22, SGP.32 and the like. Suitably, the vehicle 12 may further include an embedded universal integrated circuit card (eUICC) configured to store at least one cellular connectivity configuration profile, for example, an embedded subscriber identity module (eSIM) profile. The transceiver 30 is further configured to communicate via a personal area network (e.g., BLUETOOTH), near-field communication (NFC), and/or any additional type of radiofrequency communication.

The plurality of input and output ports 32 receive incoming data from the plurality of first sensors 22 and the plurality of second sensors 24 and communicate the incoming data to the processor 26. The plurality of input and output ports 32 also receive outgoing data from the processor 26 and communicate the outgoing data to the plurality of first sensors 22 and the plurality of second sensors 24. The plurality of input and output ports 32 are configured to wirelessly communicate with the plurality of first sensors 22 and the plurality of second sensors 24 via the transceiver 30 and are also configured to communicate with the plurality of first sensors 22 and the plurality of second sensors 24 through a Universal Serial Bus (USB) wired connection.

The controller 18 may further include one or more applications. The application is a software program configured to perform a specific function or set of functions. The applications may include one or more computer programs, software components, sets of instructions, procedures, functions, objects, classes, instances, related data, or a portion thereof adapted for implementation in a suitable computer readable program code. The applications may be stored within the memory 28 or in additional or separate memory.

The controller 18 is in electrical communication with the plurality of first sensors 22 and the plurality of second sensors 24. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 18 are within the scope of the present disclosure.

The display 20 is a screen that is located within the vehicle 12 that has a human-machine interface that presents data received by the plurality of first sensors 22 and the plurality of second sensors 24, as well as allows the user 14 to configure the vehicle 12, and run the applications included in the controller 18. The display 20 is an optional feature, meaning the display 20 is not required for the proper use or functionality of the vehicle 12, the plurality of first sensors 22, the plurality of second sensors 24, or any other part of the system 10.

The plurality of first sensors 22 are located within the vehicle 12 and are used to acquire a first input. The first input comprises information relevant to an internal driving environment within the vehicle 12. In an exemplary embodiment, the plurality of first sensors 22 includes a plurality of microphones 36, a plurality of cameras 38, and an eye tracker 40.

The plurality of microphones 36 are located throughout the vehicle 12 and receive audio data from within the vehicle 12. The audio data is then communicated to the processor 26 to be analyzed and determine the presence of the internal driving environment within the vehicle 12. It should be appreciated that only one microphone 36 may be employed without departing from the scope of the present disclosure.

The plurality of cameras 38 are located throughout the vehicle 12 and receive visual data from within the vehicle 12. The visual data is then communicated to the processor 26 to be analyzed and in order to determine the presence of the internal driving environment within the vehicle 12. It should be appreciated that only one camera 38 may be employed without departing from the scope of the present disclosure.

The eye tracker 40 is located in front of a driver's seat (not shown) of the vehicle 12 and is positioned in a way that would allow the eye tracker 40 to clearly see the eyes of the user 14 sitting in the driver's seat of the vehicle 12. The eye tracker 40 receives eye tracking data from the user 14 sitting in the driver's seat of the vehicle 12. The eye tracking data is then communicated to the processor 26 to be analyzed and determine the presence of the internal driving environment within the vehicle 12.

The plurality of second sensors 24 are mounted to the vehicle 12 and are used to acquire a second input 42. The second input 42 includes information relevant to an external driving environment surrounding the vehicle 12. In an exemplary environment, the plurality of second sensors 24 includes a speedometer 44, an accelerometer 46, a thermometer 48, a global navigation satellite system (GNSS) 50, a clock 52, a detected speed limit sensor 54, and a precipitation intensity sensor 56.

The speedometer 44 is used to provide data of an indication of a current speed of the vehicle 12. In non-limiting examples, the speedometer 44 can be a mechanical speedometer that uses a magnetic field to induce the rotation of a speed cup to determine the vehicle's 12 speed or an electronic speedometer that uses pulse generation to determine the vehicle's 12 speed. The current speed of the vehicle 12 is then communicated to the processor 26 to be analyzed and determine the current state of the external driving environment surrounding the vehicle 12.

The accelerometer 46 is used to provide data of an indication of a current acceleration of the vehicle 12. In non-limiting examples, the accelerometer 46 can be a piezoelectric accelerometer, a piezoresistive accelerometer, or a capacitive accelerometer. The current acceleration of the vehicle 12 is then communicated to the processor 26 to be analyzed and determine the current state of the external driving environment surrounding the vehicle 12.

The thermometer 48 is used to provide data of an indication of a current temperature of the environment surrounding the vehicle 12. In non-limiting examples, the thermometer 48 can be a liquid-in-glass thermometer, a bimetallic strip thermometer, an electronic thermometer, or an infrared thermometer. The current temperature is then communicated to the processor 26 to be analyzed and determine the current state of the external driving environment surrounding the vehicle 12.

The GNSS 50 is used to determine a geographical location of the vehicle 12. In an exemplary embodiment, the GNSS 50 is a global positioning system (GPS). In a non-limiting example, the GPS includes a GPS receiver antenna (not shown) and a GPS controller (not shown) in electrical communication with the GPS receiver antenna. The GPS receiver antenna receives signals from a plurality of satellites, and the GPS controller calculates the geographical location of the vehicle 12 based on the signals received by the GPS receiver antenna. In an exemplary embodiment, the GNSS 50 additionally includes a map. The map includes information about infrastructure such as municipality borders, roadways, railways, sidewalks, buildings, and the like. Therefore, the geographical location of the vehicle 12 is contextualized using the map information. In a non-limiting example, the map is retrieved from a remote source using a wireless connection. In another non-limiting example, the map is stored in a database of the GNSS 50. It should be understood that additional types of satellite-based radionavigation systems, such as, for example, Galileo, Globalnaya Navigazionnaya Sputnikovaya Sistema (GLONASS), and the BeiDou Navigation Satellite System (BDS) are within the scope of the present disclosure. It should be understood that the GNSS 50 may be integrated with the controller 18 (e.g., on a same circuit board with the controller 18 or otherwise a part of the controller 18) without departing from the scope of the present disclosure. The geographical location of the vehicle 12 is then communicated to the processor 26 to be analyzed and determine the current state of the external driving environment surrounding the vehicle 12.

The clock 52 is used to provide data of an indication of a current time of day of the environment surrounding the vehicle 12. The current time of day is then communicated to the processor 26 to be analyzed and determine the current state of the external driving environment surrounding the vehicle 12.

The detected speed limit sensor 54 is used to provide data of an indication of a posted legal speed limit of a roadway that the vehicle 12 is currently traveling on. In an exemplary, non-limiting embodiment, the posted legal speed limit data is received from the GNSS 50. The posted legal speed limit is then communicated to the processor 26 to be analyzed and determine the current state of the external driving environment surrounding the vehicle 12.

The precipitation intensity sensor 56 is used to provide data of an indication of the presence, type, and amount of precipitation (precipitation data) in the environment surrounding the vehicle 12. In an exemplary, non-limiting embodiment, the precipitation intensity sensor 56 uses an infrared light to determine the amount of precipitation where it can be determined that there is less precipitation in the environment surrounding the vehicle 12 when a high amount of the infrared light released is reflected back into the precipitation intensity sensor 56. Accordingly, it can be determined that there is more precipitation in the environment surrounding the vehicle 12 when a low amount of the infrared light released is reflected into the precipitation intensity sensor 56, as the precipitation scatters the infrared light in several different directions. Non-limiting examples of precipitation include rain and snow. The precipitation data is then communicated to the processor 26 to be analyzed and determine the current state of the external driving environment surrounding the vehicle 12.

The user 14 is an individual who is within the vehicle 12 while the vehicle 12 is in operation. The user 14 can be a driver of the vehicle 12 or a passenger in the vehicle 12. The user 14 is determined to be a driver when the user 14 is in the driver's seat of the vehicle 12. The user 14 is determined to be a passenger when the user 14 is not in the driver's seat of the vehicle 12. The vehicle 12 determines the identity of the user 14 using the plurality of first sensors 22 and records the identity as a user profile in a user profile database 58 in the memory 28.

The server 16 can be a computing device (e.g., including one or more controllers, every controller including one or more processors and one or more memories, programmed to provide operations and to execute instructions). Further, the server 16 can be accessed via a network (e.g., the Internet or some other wide area network). The server can communicate a third input 60 to the vehicle 12 using the transceiver 30. The third input 60 includes further information relevant to the external driving environment surrounding the vehicle 12, as will be described in greater detail below.

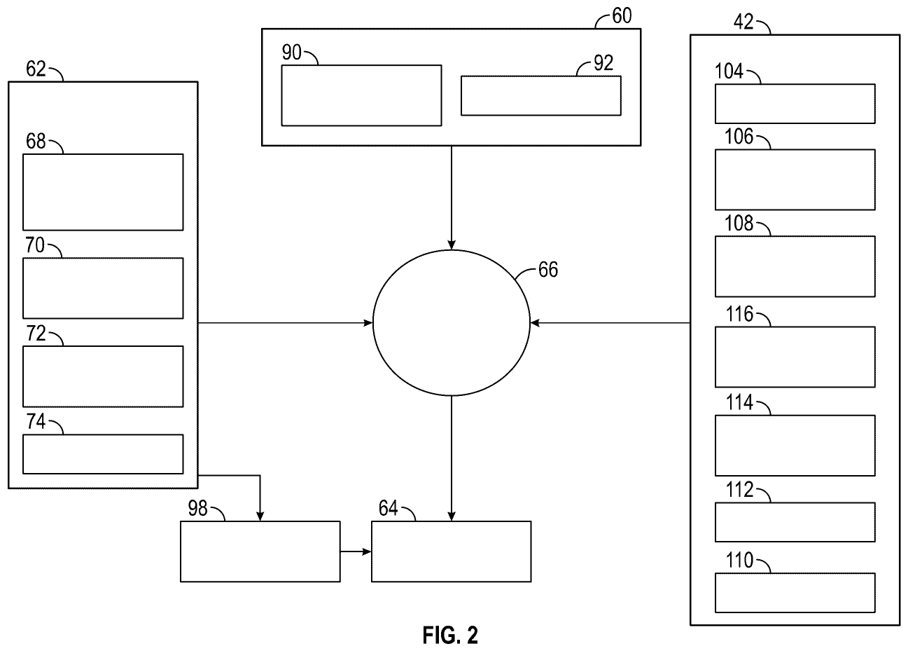

Referring to FIG. 2, a diagram of the weighing of a set of internal vehicle condition factors 62, the second input 42, and the third input 60 to determine a contextualized risk factor 64 is shown. The set of internal vehicle condition factors 62, the second input 42, and the third input 60 are provided to a weighing algorithm 66 that weighs the internal vehicle condition factors 62, the second input 42, and the third input 60 with respect to the identity of the user 14 to generate the contextualized risk factor 64.

The internal vehicle condition factors 62 are based on the data received in the first input after being analyzed by the processor 26 and indicate the internal driving environment within the vehicle. The internal vehicle condition factors 62 include: a user mental and emotional state assessment 68, an excessive disturbance factor 70, a user affected speech factor 72, and a number of passengers factor 74.

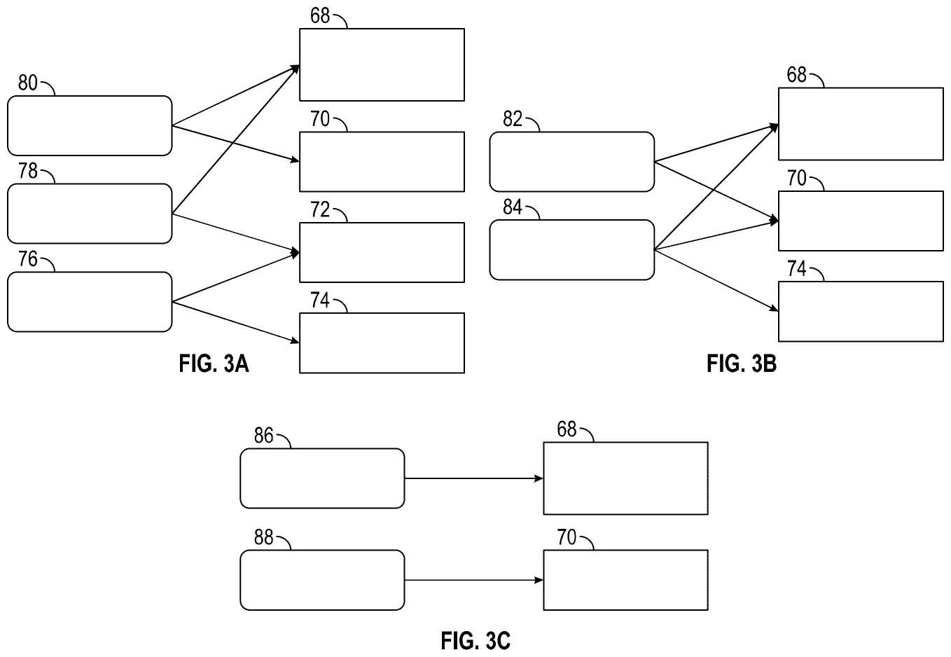

Referring to FIG. 3A, a diagram for determining the set of internal vehicle condition factors 62 based on data received from the plurality of microphones 36 is shown. The first input can comprise three types of data: audio data, visual data, and eye tracking data. The plurality of microphones 36 receive data that comprises the audio data, which is then communicated to and analyzed by the processor 26. The analysis of the audio data that is performed by the processor 26 includes a voice recognition program 76 of the user 14 and a sentiment analysis program 78 of the user 14, as well as generating a speech transcription 80 of the audio data. The eye tracker 40 receives data that comprises the eye tracking data, which is then communicated to and analyzed by the processor 26. It should be appreciated that the analysis of the audio data is conducted on each user 14 within the vehicle 12, no matter the number of users within the vehicle 12.

The voice recognition program 76 is a program executed by the processor 26 that allows the vehicle 12 to determine the identity of the user 14 based on the unique voice of the user 14. The voice recognition program 76 may also be used to provide a base-line for the voice of the user 14 that can be measured against when the voice of the user 14 becomes affected. In an exemplary, non-limiting embodiment, the voice recognition program 76 can be performed using machine learning models, deep learning models, and/or other techniques, including feature extraction (e.g., Mel-Frequency Cepstral Coefficients (MFCCs), linear predictive coding (LPC), etc.), acoustic modeling (e.g., Hidden Markov Models (HMMs), Deep Neural Networks (DNNs), etc.), speaker embeddings (e.g., i-Vectors, x-Vectors, etc.), and sequence-to-sequence models. In an example, when there are two users within the vehicle 12, one driver and one passenger, the voice recognition program 76 will allow the vehicle to distinguish between the driver user and the passenger user based on the differences between the driver user and the passenger users'unique vocal features and attributes, including pitch, timbre, formant frequencies, speaking rate, intensity, voice onset time (VOT), harmonics-to-noise ratio (HNR), prosody, and more.

The sentiment analysis program 78 of the user 14 is a program executed by the processor 26 that allows the vehicle 12 to determine the sentiment of the user 14 via the voice of the user 14. The sentiment analysis program 78 may also be used to provide a base-line emotional state of the user 14 that can be measured against when the emotional state of the user 14 changes. In an exemplary, non-limiting embodiment, the sentiment analysis program 78 can be performed using lexicon-based methods, machine learning models, or deep learning models. In conjunction with the voice recognition program 76, the sentiment analysis program 78 of the voice of the user 14 is then recorded and associated with the user's 14 corresponding user profile in the user profile database 58. In an example, when there is one user within the vehicle 12, the sentiment analysis program 78 can determine the emotional tone behind the driver user's voice and words, including whether the driver user is happy, sad, angry, fearful, surprised, anxious, stressed, etc.

The speech transcription 80 is a program that takes the audio data received by the plurality of microphones 36 and transcribes the audio data into words that are recorded in a file that can later be read. In an exemplary, non-limiting embodiment, the speech transcription 80 can be generated by an automated speech recognition algorithm (ASR), machine learning models, or deep learning models. In conjunction with the voice recognition program 76, the speech transcription is associated with the user's 14 corresponding user profile in the user profile database 58.

Referring to FIG. 3B, a diagram for determining the set of internal vehicle condition factors 62 based on data received from the plurality of cameras 38 is shown. The plurality of cameras 38 receive data that comprises the visual data, which is then communicated to and analyzed by the processor 26. The analysis of the visual data that is performed by the processor 26 includes driver activity tracker 82 and passenger activity tracker 84. It should be appreciated that the analysis of the visual data is conducted on each user 14 within the vehicle 12, no matter the number of users within the vehicle 12.

The driver activity tracker 82 is a program that takes the visual data received by the plurality of cameras 38 to monitor the behavior of a driver user. The behavior of the driver user is then recorded and associated with the driver user's corresponding user profile in the user profile database 58. In an example, when there is a driver user and a passenger user within the vehicle 12 and the driver user frequently takes their hands of a steering wheel of the vehicle 12 to make gestures while talking to the passenger user, the driver user's behavior is recorded and associated with the driver user's user profile in the user profile database 58.

The passenger activity tracker 84 is a program that takes the visual data received by the plurality of cameras 38 to monitor the behavior of a passenger user. The behavior of the passenger user is then recorded and associated with the passenger user's corresponding user profile in the user profile database 58. In an example, when there is a driver user and a passenger user within the vehicle 12 and the passenger user frequently touches the driver user while the driver user is operating the vehicle 12, the passenger user's behavior is recorded and associated with the passenger user's user profile in the user profile database 58.

Referring to FIG. 3C, a diagram for determining the set of internal vehicle condition factors 62 based on data received from the eye tracker 40 is shown. The analysis of the eye tracking data that is performed by the processor 26 includes a pupil dilation detector 86 and a gaze tracker 88. It should also be appreciated that the analysis of the eye tracking data is conducted only on the user 14 when the user 14 is determined to be a driver.

The pupil dilation detector 86 is a program that takes the eye tracking data received by the eye tracker 40 and detects the emotional state of the user 14 based on the size of the pupils of the user 14. In an example, when the pupils of the user 14 are dilated, that may indicate that the user 14 is excited or has a heightened sense of alertness. In another example, when the pupils of the user 14 are constricted, that may indicate that the user 14 is calm, bored, or fatigued. The emotional state of the user 14 is then recorded and associated with the user's 14 corresponding user profile in the user profile database 58.

The gaze tracker 88 is a program that takes the eye tracking data received by the eye tracker 40 and detects the trajectory of the gaze of the user 14, which can assist in determining whether the user 14 who is a driver is keeping their attention directed toward a roadway the vehicle 12 is traveling on while the user 14 is operating the vehicle 12. In an example, when the user 14 frequently keeps their eyes on the roadway, this behavior is recorded and associated with the user's 14 corresponding user profile in the user profile database 58. In another example, when the user 14 frequently takes their eyes off the roadway, this behavior is recorded and associated with the user's 14 corresponding user profile in the user profile database 58.

Referring to FIGS. 3A, 3B, and 3C, the user mental and emotional state assessment 68 provides data regarding the mental and emotional state of the user 14, such as excitement, peer pressure, rowdiness, and other emotional states. The user mental and emotional state assessment 68 is determined from the sentiment analysis program 78, the speech transcription 80, the driver activity tracker 82, the passenger activity tracker 84, and the pupil dilation detector 86.

The excessive disturbance factor 70 detects the presence of a disturbance within the vehicle 12 that may increase the potential of an internal risky driving environment within the vehicle 12. In a non-limiting example, the excessive disturbance factor 70 may be the presence of backseat driving within the vehicle 12, where a passenger user is providing unsolicited advice to a driver user with respect to how the vehicle 12 should be operated. In another non-limiting example, the excessive disturbance factor 70 may be frequent device (e.g., a cellphone, tablet, smart watch, etc.) usage by a driver user during the operation of the vehicle 12. In other non-limiting examples, the excessive disturbance factor 70 may be loud noises coming from within or outside of the vehicle 12, a driver user frequently adjusting controls within the vehicle 12 (e.g., a radio, a climate control system, a navigation system, etc.), a driver user reaching for objects (e.g., a cellphone, a purse, etc.) in another part of the vehicle 12 while operating the vehicle 12, a driver user consuming food or beverages while operating the vehicle 12, a driver user grooming themselves (e.g., combing hair, applying makeup, etc.) while operating the vehicle 12, and a passenger user engaging in distracting behavior for a driver user (e.g., talking loudly, making exaggerated gestures towards the driver user, etc.). The excessive disturbance factor 70 is determined from the speech transcription 80, the driver activity tracker 82, the passenger activity tracker 84, and the gaze tracker 88.

The user affected speech factor 72 detects whether the speech of the user 14 has become affected to an extent that the speech has notably departed from the base-line that the voice recognition program 76 has associated with the user 14 and/or the base-line emotional state that the sentiment analysis program 78 has associated with the user 14. In a non-limiting example, affected speech may be that the user's 14 voice is slurred compared to the base-line. In other non-limiting examples, affected speech may be that the user's 14 voice is notably slower compared to the base-line, or is notably faster than the base-line. The user affected speech factor 72 is determined from the voice recognition program 76 and the sentiment analysis program 78.

The number of passengers factor 74 detects the number of passenger users within the vehicle 12. The number of passengers factor 74 is determined from the voice recognition program 76 and the passenger activity tracker 84.

Returning to FIG. 2, the second input 42 is the data received by the plurality of second sensors 24. The second input 42 includes the current speed of the vehicle 104, the current acceleration of the vehicle 106, the current temperature of the environment surrounding the vehicle 108, the geographic location of the vehicle 110, the current time of day of the environment surrounding the vehicle 112, the posted legal speed limit of the roadway the vehicle is traveling on 114, and the precipitation data with respect to the environment surrounding the vehicle 116.

The third input 60 is data received from a plurality of third-party sources over the server 16. The third input 60 includes weather conditions data 90 and traffic conditions data 92.

The weather conditions data 90 is data regarding the current weather conditions of the environment surrounding the vehicle 12, including a forecasted start time and time period of sunshine, clouds, rain, snow, hail, thunderstorms, blizzards, tornadoes, hurricanes, floods, fog, etc. The weather conditions data 90 is provided over the server 16 by a weather service.

The traffic conditions data 92 is data regarding the current traffic conditions of the environment surrounding the vehicle 12, a non-limiting list including the number of vehicles traveling over a roadway over a period of time, the speed of the vehicles traveling over the roadway over the period of time, roadway closures, lane closures, the presence of construction on the roadway, the presence of another vehicle on the shoulder of the roadway, and the presence of a vehicle accident on the roadway. The traffic conditions data 92 is provided over the server 16 by a traffic service.

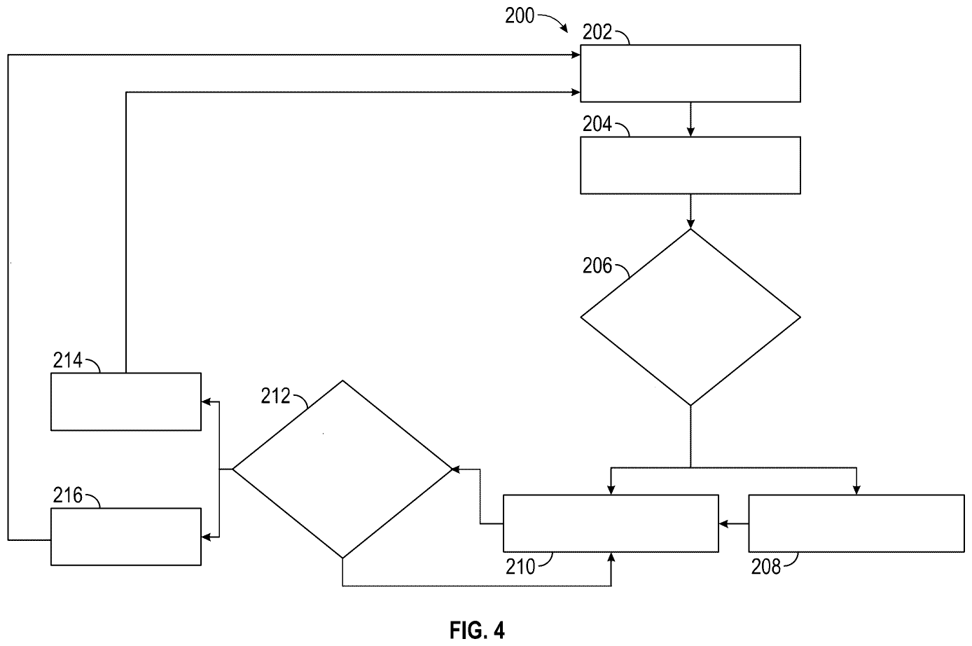

Referring to FIG. 4, a flowchart of a method for determining which of either at least one of a plurality of indirect measures or at least one of a plurality of direct measures the vehicle 12 will take based on the contextualized risk factor 64 is generally indicated by reference number 200. In this example, it is presumed that the user 14 is a driver operating the vehicle 12. The method 200 begins at step 202 by determining the contextualized risk factor 64 based on the internal vehicle condition factors 62, the second input 42, and the third input 60 with respect to a plurality of historical/heuristic data points 98 associated with the user's 14 user profile.

The contextualized risk factor 64 is a dynamic value that is determined by weighing the internal vehicle condition factors 62, the second input 42, and the third input 60 with respect to the identity of the users within the vehicle 12 using the weighing algorithm 66. Once the internal vehicle condition factors 62, the second input 42, and the third input 60 are received, the processor 26 detects recurring trends and correlations between the user 14, the emotional state of the user 14, and the driving behaviors of the user 14, which are recorded in the plurality of historical/heuristic data points 98 associated with the user's 14 user profile. The processor 26 will then determine and correlate the internal vehicle condition factors 62, the second input 42, and the third input 60 and their respective thresholds that lead to the creation of an unsafe driving environment. The respective thresholds of the internal vehicle condition factors 62, the second input 42, and the third input 60 can then be tested via subsequent unsafe driving environments to test and validate the respective thresholds to ensure accuracy in their ability to detect the unsafe driving environment.

At step 204 the method 200 records the behavior of the user 14 into the plurality of historical/heuristic data points 98 associated with the user's 14 user profile. The plurality of historical/heuristic data points 98 are used to refine and adjust thresholds for determining whether any of the internal vehicle condition factors 62, the second input 42, and the third input 60 contributes to the presence of the unsafe driving environment, allowing for more precise and effective identifications of behaviors that contribute to the unsafe driving environment. The plurality of historical/heuristic data points 98 can also be used to develop and improve mitigation strategies to reduce the presence of the unsafe driving environment, which will be discussed further below. When there is more than one user within the vehicle 12, step 204 is repeated for every user within the vehicle 12.

In an example, when there is a driver user and a passenger user within the vehicle 12 and the passenger user engages in a distracting behavior (i.e. touching the driver user) while the driver user is operating the vehicle 12, the behavior of the driver user and the passenger user 14 is observed by the plurality of second sensors 24 and associated with the driver user's and passenger user's corresponding user profile. When the driver user's operational ability remains unaffected by the passenger user's behavior (e.g., the driver user keeps both hands on the steering wheel of the vehicle 12, the driver user's gaze trajectory remains on the roadway, the voice recognition program 76 does not detect that the driver user is displaying affected speech, etc. despite the behavior of the passenger user), the internal vehicle condition factors 62 will not be given a considerable degree of weight when determining the contextualized risk factor 64. The driver user's behavior is also recorded in the plurality of historical/heuristic data points 98 associated with the driver user's user profile. This means that when a future driving scenario occurs where the same driver user and same passenger user engage in similar behavior, the internal vehicle condition factors 62 will be given less weight when determining the contextualized risk factor 64. This means that the behavior of the driver user will not be considered as risky to the driving environment of the vehicle 12 when the behavior of the passenger user is repeated in the future and the behavior of the driver user remains the same.

Conversely, in another example, when there is a driver user and a passenger user within the vehicle 12 and the passenger user frequently touches the driver user while the driver user is operating the vehicle 12, when the driver user's operational ability becomes affected by the passenger user's behavior (e.g., the driver user takes their hands of the steering wheel of the vehicle 12, the driver user's gaze trajectory is not on the roadway, the voice recognition program 76 detects that the driver user is displaying affected speech, etc. because of the behavior of the passenger user), the internal vehicle condition factors 62 will be given a considerable degree of weight when determining the contextualized risk factor 64. The driver user's behavior is also recorded in the plurality of historical/heuristic data points 98 associated with the driver user's user profile. This means that when a future driving scenario occurs where the same driver user and same passenger user engage in similar behavior, the internal vehicle condition factors 62 will be given more weight when determining the contextualized risk factor 64. Furthermore, the behavior of the driver user will continue to be considered risky to the driving environment of the vehicle 12 when the behavior of the passenger user is repeated in the future and the behavior of the driver user remains the same. The behavior of the driver user may be determined to be increasingly risky after each subsequent similar driving situation when the driver user's operational ability becomes more affected by the passenger user's behavior (e.g., the driver user takes their hands off the steering wheel of the vehicle 12 for a significant period of time, the driver user's gaze trajectory is not on the roadway for a significant period of time, the voice recognition program 76 detects that the driver user is displaying affected speech for a significant period of time, etc. because of the behavior of the passenger user). This means that the internal vehicle condition factors 62 will be given a significant amount more weight when determining the contextualized risk factor 64 upon each subsequent similar driving situation.

It should be appreciated that the internal vehicle condition factors 62 are also weighted based on the identity of a passenger user. In an example when there is a driver user, a first passenger user, and a second passenger user, when the driver user's operational ability remains unaffected by the distracting behavior of the first passenger user but the driver user's operational ability becomes affected by the distracting behavior of the second passenger user, the internal vehicle condition factors 62 will be given more weight when the second passenger user is engaged in the distracting behavior while the internal vehicle condition factors 62 will be given less weight when the first passenger user is engaged in the distracting behavior when the first passenger user and the second passenger user are engaged in the distracting behavior at different times despite the distracting behavior being identical. The first passenger user and the second passengers'behavior is also recorded in the plurality of historical/heuristic data points 98 associated with the first passenger's user profile and the second passenger's user profile respectively, meaning that the internal vehicle condition factors 62 when a future driving situation arises can be weighted dynamically based on the past behaviors of the driver user, the first passenger user, and the second passenger user.

It should also be appreciated that, no matter the driving situation, the internal vehicle condition factors 62, the second input 42, and the third input 60 are recorded in the plurality of historical/heuristic data points 98 for each respective user within the vehicle 12. This means that when a future driving situation arises, the internal vehicle condition factors 62, the second input 42, and the third input 60 can be weighted dynamically based on the past behaviors of each respective user within the vehicle 12. The method 200 then proceeds to step 206.

At step 206 the method 200 compares the contextualized risk factor 64 to a calibrated safety threshold. When the contextualized risk factor 64 is greater than an arbitrary first margin above the calibrated safety threshold, the method 200 then proceeds to step 208.

The calibrated safety threshold is a dynamic value that the contextualized risk factor 64 is compared to determine whether the vehicle 12 needs to take one of the plurality of indirect measures or one of the plurality of direct measures based on the existence of the unsafe driving environment. The calibrated safety threshold is determined based on the respective thresholds of the internal vehicle condition factors 62, the second input 42, and the third input 60 with respect to the plurality of historical/heuristic data points 98 in the user profile of the user 14.

At step 208, the method 200 has the vehicle 12 take at least one of the plurality of indirect measures. After the vehicle 12 takes at least one of the plurality of indirect measures, when the contextualized risk factor 64 continues to be greater than the arbitrary first margin above the calibrated safety threshold over a period of time, the method 200 may repeat step 208. When the contextualized risk factor 64 falls below the calibrated safety threshold, the method 200 restarts at step 202.

Returning to step 208, when the contextualized risk factor 64 continues to be greater than the arbitrary first margin above the calibrated safety threshold over a period of time or becomes greater than an arbitrary second margin above the calibrated safety threshold at an instantaneous time, the method 200 will then continue to step 210. It should be noted that the arbitrary second margin is greater than the arbitrary first margin.

The plurality of indirect measures are several possible actions the vehicle 12 may take after the contextualized risk factor 64 is greater than the arbitrary first margin above the calibrated safety threshold to reduce the risk of operating the vehicle 12 in the unsafe driving environment or to reduce the presence of the unsafe driving environment. In an exemplary, non-limiting embodiment, the plurality of indirect measures includes providing safety alerts and warnings to the user 14 through the systems within the vehicle 12 (e.g., on the display 20, over a plurality of speakers, etc.) about which of the internal vehicle condition factors 62, the second input 42, and the third input 60 are contributing to the detection of the unsafe driving environment and how, if possible, the user 14 can reduce the risk of operating the vehicle 12. In another exemplary, non-limiting embodiment, the plurality of indirect measures includes playing calming and relaxing sounds or music over the plurality of speakers within the vehicle 12 when the user mental and emotional state assessment 68 detects exhibited emotions by the user 14 that can contribute to the unsafe driving environment (e.g., anger, stress, anxiety, etc.).

At step 210 the method 200 uses the plurality of first sensors 22, the plurality of second sensors 24, and the third input 60 to monitor the environment surrounding the vehicle 12. The method 200 then continues to step 212.

At step 212 the vehicle 12, based on the second input 42 and the third input 60, determine whether the environment surrounding the vehicle 12 is suitable to limit the vehicle's 12 agility without amplifying the nature of the unsafe driving environment. In an example, when the vehicle 12 is traveling on a straight roadway without negative driving conditions (e.g., inclement weather, traffic, construction, etc.), the vehicle 12 will determine that the environment surrounding the vehicle 12 is suitable to limit the vehicle's 12 agility. The vehicle's 12 agility is the vehicle's 12 ability to accelerate and maneuver in an environment. In another example when the vehicle 12 is traveling on a windy roadway and the vehicle detects negative driving conditions, the vehicle 12 will not limit the vehicle's 12 agility despite the contextualized risk factor 64 until the vehicle 12 determines that taking at least one of the plurality of direct measures will not amplify the nature of the unsafe driving environment created by the negative driving conditions.

The plurality of direct measures are several possible actions the vehicle 12 may take after the contextualized risk factor 64 is greater than the arbitrary second margin above the calibrated safety threshold or when the contextualized risk factor 64 persists in being greater than the arbitrary first margin above the calibrated safety threshold after the vehicle takes at least one of the plurality of indirect measures to reduce the risk of operating the vehicle 12 in the unsafe driving environment or to reduce the presence of the unsafe driving environment. In an exemplary, non-limiting embodiment, the plurality of direct measures includes temporarily limiting the possible maximum speed of the vehicle 12 for a period of time. In another exemplary, non-limiting embodiment, the plurality of direct measures includes temporarily limiting the possible maximum acceleration of the vehicle 12 for a period of time. When the vehicle 12 determines the environment surrounding the vehicle 12 is suitable to limit the vehicle's 12 agility, the method 200 may continue to step 214.

At step 214 the method 200 temporarily limits the possible maximum speed of the vehicle 12 for a period of time until the contextualized risk factor 64 falls below the calibrated safety threshold. The method 200 then restarts at step 202.

Returning to step 212, when the vehicle 12 determines the environment surrounding the vehicle 12 is suitable to limit the vehicle's 12 agility, the method 200 may continue to step 216.

At step 216 the method 200 temporarily limits the possible maximum acceleration of the vehicle 12 for a period of time until the contextualized risk factor 64 falls below the calibrated safety threshold. The method 200 then restarts at step 202.

Returning to step 206, when the contextualized risk factor 64 is greater than the arbitrary second margin above the calibrated safety threshold, the method 200 then proceeds to step 210.

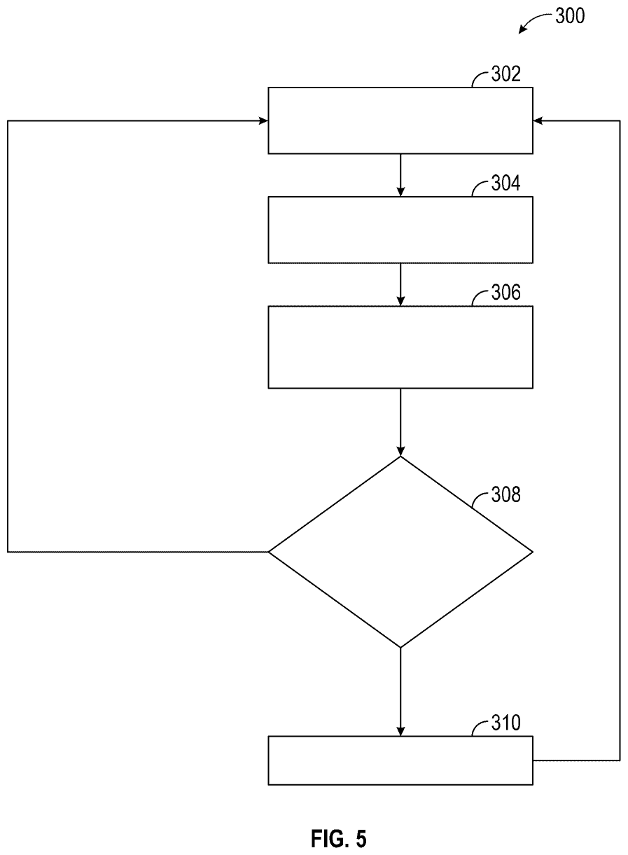

Referring to FIG. 5, a flowchart of a method for determining when to provide a warning alert to a third-party based on the contextualized risk factor is generally indicated by reference number 300. In this example, it is presumed that the user 14 is a driver operating the vehicle 12. It should also be appreciated that while in this example, the vehicle 12 is performing the method 300, the method 300 can be employed by any wearable device by the user 14, including a watch, a bracelet, a locket, etc.

The method 300 begins at step 302 by determining the contextualized risk factor 64 based on the internal vehicle condition factors 62, the second input 42, and the third input 60 with respect to the plurality of historical/heuristic data points 98 associated with the user profile of the user 14. When there is more than one user within the vehicle 12, step 302 is repeated for every user within the vehicle 12. The method 300 then proceeds to step 304.

At step 304 the method 300 records the behavior of the user 14 into the plurality of historical/heuristic data points 98 associated with the user profile of the user 14. When there is more than one user within the vehicle 12, step 304 is repeated for every user within the vehicle 12. The method 300 then proceeds to step 306.

At step 306 the method 300 generates and shares a contextualized driving behavior report of the user 14 with a third-party. The contextualized driving behavior report includes the plurality of historical/heuristic data points 98 associated with the user profile of the user 14. The third-party is an individual or a group that has either a relationship with the user 14 (e.g., a parent of the user 14, a guardian of the user 14, a custodian of the user 14, an employer of the user 14, etc.) or has an interest in the maintenance of the vehicle 12 (i.e. an owner of the vehicle 12). The method 300 then proceeds to step 308.

At step 308 the method 300 compares the contextualized risk factor 64 with the calibrated safety threshold to determine whether to alert a third-party to the presence of the unsafe driving environment. When the contextualized risk factor 64 is not greater than the arbitrary second margin above the calibrated safety threshold, the third-party is not alerted to the presence of the unsafe driving environment and the method 300 returns to step 302. When the contextualized risk factor 64 is greater than the arbitrary second margin above the calibrated safety threshold, the method 300 then proceeds to step 310.

At step 310 the method 300 alerts the third-party to the presence of the unsafe driving environment. The method 300 then restarts at step 302.

Returning to step 308, when the contextualized risk factor 64 is not greater than the arbitrary second margin above the calibrated safety threshold, the method 300 then restarts at step 302.

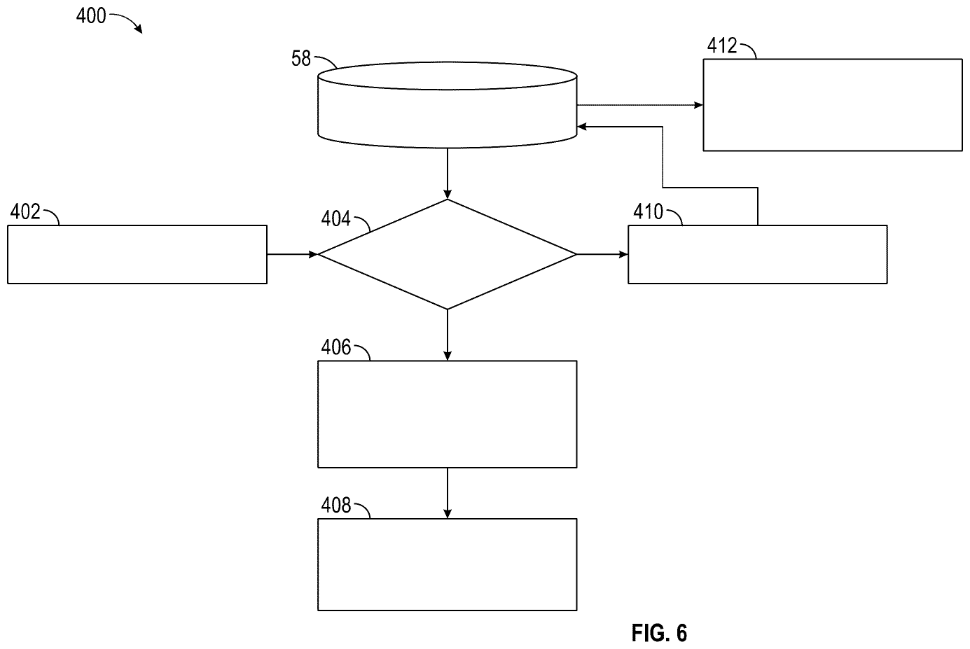

Referring to FIG. 6, a flowchart of a method for adding a user profile to a user profile database is generally indicated by reference number 400. The method 400 begins at step 402 by receiving identity data from the plurality of first sensors 22 that may allow the vehicle 12 to determine the identity of the user 14. In an exemplary, non-limiting embodiment, the identity data includes data received by the voice recognition program 76. In another exemplary, non-limiting embodiment, the identity data includes data received by a face recognition 102.

The face recognition 102 is a program executed by the processor 26 that allows the vehicle 12 to determine the identity of the user 14 based on the unique face of the user 14. In an exemplary, non-limiting embodiment, the face recognition 102 can be performed using machine learning models, deep learning models, or other techniques including convolutional neural networks (CNNs), DeepFace, OpenFace, FaceNet, and DLib. In an example, when there are two users within the vehicle 12, one driver and one passenger, the face recognition 102 will allow the vehicle to distinguish between the driver user and the passenger user based on the differences between the driver user and the passenger users'unique facial features and attributes, including face shape, nose shape, nose position, eye shape, eye color, distance between eyes, mouth and lip contours, cheekbone structure, jawline and chin shape, forehead to chin distance, and more. The method 400 then proceeds to step 404.

At step 404 the method 400 then determines whether the user profile of the user 14 exists in the user profile database 58 by determining whether there is a user profile in the user profile database 58 that matches the voice recognition program 76 and/or the face recognition 102 of the user 14 based on the identity data received by the plurality of first sensors 22. When the voice recognition program 76 and/or the face recognition 102 matches a user profile found in the user profile database 58, the method 400 then proceeds to step 406.

At step 406 the method 400 retrieves the plurality of historical/heuristic data points 98 from the user profile associated with the user 14 to consider the plurality of historical/heuristic data points 98 while weighing the internal vehicle condition factors 62, the second input 42, and the third input 60 to determine the contextualized risk factor 64. The method 400 then proceeds to step 408.

At step 408 the method 400 associates the behavior of the user 14 with the corresponding user profile and records the behavior in the plurality of historical/heuristic data points 98 from the corresponding user profile.

Returning to step 404, when the voice recognition program 76 and/or the face recognition 102 does not match a user profile found in the user profile database 58, the method 400 then proceeds to step 410.

At step 410 the method 400 creates a user profile based on the identity data received by the plurality of first sensors 22 and adds the user profile to the user profile database 58. The method 400 then proceeds to step 412.

At step 412 the method 400 associates the behavior of the user 14 with the corresponding user profile and records the behavior in the plurality of historical/heuristic data points 98 from the corresponding user profile.

The contextualized risk factor 64 of the present disclosure offers several advantages. These include the mitigation of the unsafe driving environment due to distracting factors both inside and outside the vehicle 12, proactive safety measures that allow the vehicle 12 to intervene before the risk of driving in the unsafe driving environment increases, providing a contextualized driving behavior report to a third-party that would allow the third-party to address unsafe behavior the user 14 is engaged in, and a streamlined method of emotional and mental health monitoring of the user 14 by providing the user mental and emotional state assessment that can allow the user 14 to better understand their mental health.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for mitigating the risk of operating a vehicle using contextual information related to a user of the vehicle and an operating condition of the vehicle, the method comprising:
receiving a first input from a plurality of first sensors located within the vehicle, wherein the first input is indicative of an internal condition within the vehicle;
determining an identity of a user based on the first input and a user profile in a user profile database;
determining a set of internal vehicle condition factors of the internal condition within the vehicle based on the first input and the identity of the user;
receiving a second input from a plurality of second sensors mounted to the vehicle, wherein the second input is indicative of the operating condition of the vehicle;
determining a contextualized risk factor based on the internal vehicle condition factors and the second input;
comparing the contextualized risk factor to a calibrated safety threshold; and
performing at least one action when the contextualized risk factor is above the calibrated safety threshold to mitigate the risk of operating the vehicle.

2. The method from claim 1, wherein receiving the first input further comprises:
receiving the first input using at least one microphone;
determining that the first input is human speech;
generating a transcript of the first input;
analyzing the first input using a sentiment analysis program; and
analyzing the first input using a voice recognition program.

3. The method from claim 2, wherein determining the identity of the user further comprises:
creating the user profile of the user based on the analysis of the first input by the voice recognition program when comparing the first input to each entry in the user profile database does not result in a match;
adding the user profile to the user profile database; and
associating the set of internal vehicle condition factors with the user in the user profile database.

4. The method from claim 2, wherein determining the set of internal vehicle condition factors comprises:
generating a user mental and emotional state assessment based on the transcript of the first input and the analysis of the first input by the sentiment analysis program;
determining when an excessive third-party disturbance occurs based on the transcript of the first input;
determining the number of users in the vehicle based on a number of users identified by the voice recognition program; and
determining when the speech of the user is affected based on the analysis of the first input by the sentiment analysis program and the analysis of the first input by the voice recognition program.

5. The method from claim 1, wherein receiving the first input further comprises:
receiving the first input using at least one camera; and
classifying the user as one of either a driver or a passenger based on the position of the user within the vehicle.

6. The method from claim 5, wherein determining the identity of the user further comprises:
analyzing the first input using a face recognition program;
creating the user profile of the user based on the analysis of the first input by the face recognition program when comparing the first input to each entry in the user profile database does not result in a match;
adding the user profile to the user profile database; and
associating the internal vehicle condition factors and the second input with the user in the user profile database.

7. The method from claim 5, wherein determining the set of internal vehicle condition factors comprises:
generating a user mental and emotional state assessment based on the activity tracked of the driver;
generating a user mental and emotional state assessment based on the activity tracked of the passenger;
determining the number of passengers in the vehicle based on the activity tracked of at least one passenger;
determining when an excessive disturbance occurs based on the activity tracked of the driver; and
determining when an excessive third-party disturbance occurs based on the activity tracked of at least one passenger.

8. The method from claim 1, wherein receiving the first input further comprises:
using at least one eye tracker to receive the first input;
determining when the pupils of the user's eyes are in a dilated state or a non-dilated state; and
determining the direction of the user's gaze.

9. The method from claim 8, wherein determining the set of internal vehicle condition factors comprises:
generating a user mental and emotional state assessment based on when the user's eyes are in the dilated state; and
determining when an excessive disturbance occurs based on the direction of the user's gaze.

10. The method from claim 1, wherein the second input further comprises:
a current speed of the vehicle;
a current acceleration of the vehicle;
a detected speed limit of a roadway the vehicle is operating on;
an ambient temperature of the environment in which the vehicle is operating;
a precipitation intensity of the environment in which the vehicle is operating;
a time of day of the environment in which the vehicle is operating; and
a location of the vehicle.

11. The method from claim 1, wherein the method further comprises:
receiving a third input from a server, wherein the third input is indicative of the environment surrounding the vehicle including weather information of the environment in which the vehicle is operating and traffic information of an environment in which the vehicle is operating.

12. The method from claim 1, wherein determining the contextualized risk factor further comprises:
weighing the set of internal vehicle condition factors, second input, and third input based on the identity of the user; and
generating the contextualized risk factor.

13. The method from claim 1, wherein performing at least one action when the contextualized risk factor is above the calibrated safety threshold further comprises:
performing an indirect measure when the contextualized risk factor is greater than an arbitrary first margin above the calibrated safety threshold;
performing the indirect measure when the contextualized risk factor persists in being relatively greater than the calibrated safety threshold over a period of time;
performing a direct measure when the contextualized risk factor persists in being greater than the arbitrary first margin above the calibrated safety threshold over a period of time; and
performing the direct measure when the contextualized risk factor is greater than an arbitrary second margin above the calibrated safety threshold, wherein the arbitrary second margin is greater than the arbitrary first margin.

14. The method from claim 13, wherein the indirect measure comprises:
playing a relaxing music track over a sound system within the vehicle; and
alerting the user to the risky operating conditions of the vehicle.

15. The method from claim 13, wherein the direct measure comprises:
temporarily limiting the speed of the vehicle; and
temporarily limiting the acceleration of the vehicle.

16. The method from claim 13, wherein performing the direct measure further comprises:
analyzing the second input; and
determining based on the second input that an environment in which the vehicle is operating is safe to limit the agility of the vehicle.

17. The method from claim 1, wherein performing at least one action when the contextualized risk factor is above the calibrated safety threshold further comprises:
alerting a third-party to the risky operating conditions of the vehicle.

18. The method from claim 11, wherein the calibrated safety threshold is adjusted based on the internal vehicle condition factors, the second input, the third input, and the identity of the user.

19. A method for mitigating the risk of operating a vehicle using contextual information related to a user of the vehicle and an operating condition of the vehicle, the method comprising:
receiving a first input from a plurality of first sensors located within the vehicle, wherein the first input is indicative of an internal condition within the vehicle;
determining an identity of a user based on the first input and a user profile in a user profile database;
determining a set of internal vehicle condition factors of the internal condition within the vehicle based on the first input and the identity of the user;
receiving a second input from a plurality of second sensors mounted to the vehicle, wherein the second input is indicative of the operating condition of the vehicle;
determining a contextualized risk factor based on the internal vehicle condition factors and the second input;
recording behavior of the user based on the internal vehicle condition factors and the second input into a plurality of historical/heuristic data points associated with the user profile;
comparing the contextualized risk factor to a calibrated safety threshold;
performing at least one action when the contextualized risk factor is above the calibrated safety threshold to mitigate the risk of operating the vehicle;
determining the at least one action is an indirect measure when the contextualized risk factor is greater than an arbitrary first margin above the calibrated safety threshold or when the contextualized risk factor persists in being relatively greater than the calibrated safety threshold over a period of time, wherein the indirect measure comprises playing a relaxing music track over a sound system within the vehicle and alerting the user to the risky operating conditions of the vehicle; and
determining the at least one action is a direct measure when an environment in which the vehicle is operating in is safe to limit the agility of the vehicle and either the contextualized risk factor persists in being greater than the arbitrary first margin above the calibrated safety threshold over a period of time or the contextualized risk factor is greater than an arbitrary second margin above the calibrated safety threshold, wherein the arbitrary second margin is greater than the arbitrary first margin, wherein the direct measure comprises temporarily limiting the speed of the vehicle and temporarily limiting the acceleration of the vehicle.

20. A method for mitigating the risk of operating a vehicle using contextual information related to a user of the vehicle and an operating condition of the vehicle, the method comprising:
receiving a first input from a plurality of first sensors located within the vehicle, wherein the first input is indicative of an internal condition within the vehicle;
determining an identity of a user based on the first input and a user profile in a user profile database;
determining a set of internal vehicle condition factors of the internal condition within the vehicle based on the first input and the identity of the user;
receiving a second input from a plurality of second sensors mounted to the vehicle, wherein the second input is indicative of the operating condition of the vehicle;
determining a contextualized risk factor based on the internal vehicle condition factors and the second input;
recording behavior of the user based on the internal vehicle condition factors and the second input into a plurality of historical/heuristic data points associated with the user profile;
comparing the contextualized risk factor to a calibrated safety threshold;
performing at least one action when the contextualized risk factor is above the calibrated safety threshold to mitigate the risk of operating the vehicle; and
alerting a third-party to the presence of an unsafe driving environment for the vehicle when the contextualized risk factor is greater than an arbitrary margin above the calibrated safety threshold.
